(19) United States
(12) Patent Application Publication
(10) Pub. No.: US 2026/0128380 A1
(43) Pub. Date: May 7, 2026

(54) Composite Electrode Plate and Battery Cell

(71) Applicant: Microvast, Inc., Stafford, TX (US)

(72) Inventors: Haojun QI, Huzhou (CN); Penghui ZHENG, Huzhou (CN); Weifeng FANG, Huzhou (CN); Wenjuan Liu MATTIS, Longwood, FL (US)

(73) Assignee: Microvast, Inc., Stafford, TX (US)

(21) Appl. No.: 18/938,308

(22) Filed: Nov. 6, 2024

(51) Int. Cl. H01M 10/0585; H01M 4/02; H01M 4/66; H01M 4/70; H01M 50/46

(52) U.S. Cl. CPC H01M 10/0585; H01M 4/662; H01M 4/70; H01M 50/46; H01M 2004/021

(57) ABSTRACT

The present invention provides a composite electrode plate including a current collector. The current collector has a first surface and a second surface that are opposite to each other. A positive electrode active material layer is provided on the first surface, and a negative electrode active material layer is provided on the second surface. The length of the current collector is L1,the length of the negative electrode active material layer is L2, and the length of the positive electrode active material layer is L3; the width of the current collector is W1, the width of the negative electrode active material layer is W2, and the width of the positive electrode active material layer is W3; wherein L1>L2>L3, and/or, W1>W2>W3. The present invention also provides a battery cell.

### TECHNICAL FIELD

This invention relates to the field of battery technology, and in particular to a composite electrode plate and a battery cell.

### BACKGROUND

In the research and application of all solid state batteries, bipolar stack structure is widely regarded as an important means to improve battery energy density and performance. Bipolar stacked solid-state battery cells generally include multiple composite electrode plates, each of which includes a current collector, and positive and negative electrode active material layers respectively arranged on opposite sides of the current collector; the multiple composite electrode plates are stacked in sequence, and adjacent composite electrode plates are separated by electrolyte layers (such as separators). The multiple composite electrode plates and the electrolyte layers are combined with each other through hot pressing process.

### SUMMARY

In order to better separate adjacent composite electrode plates, the length and width dimensions of the electrolyte layer are generally larger than those of the composite electrode plate; meanwhile, due to the relatively large thickness of the composite electrode plate, an obvious step exists between the edges of the electrolyte layer and the edges of the composite electrode plate. During the hot pressing or rolling process, the edges of the electrolyte layer are prone to damage due to excessive shear force (due to the obvious step between the edges of the electrolyte layer and the edges of the composite electrode plate, the electrolyte layer experiences greater shear force at the step positions during the hot pressing or rolling process, which makes the edges of the electrolyte layer prone to damage), resulting in internal short circuiting of the battery cell. How to reduce or avoid damage to the electrolyte layer during the hot pressing or rolling process without affecting the overall performance of the battery cell has become an urgent technical problem in the field of bipolar stacked solid-state battery manufacturing.

The object of the present invention is to provide a composite electrode plate, which forms a size gradient at the edge positions of the composite electrode plate by limiting the length and width dimensions of the current collector, the positive electrode active material layer, and the negative electrode active material layer. This reduces the step height formed between the edges of the electrolyte layer and the edges of the composite electrode plate, thereby reducing the shear force on the edges of the electrolyte layer during the hot pressing or rolling process, and reducing or avoiding damage to the electrolyte layer.

An embodiment of the present invention provides a composite electrode plate including a current collector, wherein the current collector has a length direction, a width direction, and a thickness direction, every two of which are mutually perpendicular to each other; in the thickness direction, the current collector has a first surface and a second surface that are opposite to each other; a positive electrode active material layer is provided on the first surface, and a negative electrode active material layer is provided on the second surface;
in the length direction, the length of the current collector is L1, the length of the negative electrode active material layer is L2, and the length of the positive electrode active material layer is L3; in the width direction, the width of the current collector is W1, the width of the negative electrode active material layer is W2, and the width of the positive electrode active material layer is W3; wherein L1>L2>L3, and/or W1>W2>3.

In an achievable manner, the first surface includes a positive electrode active area and a positive electrode blank area, the positive electrode active material layer is arranged within the positive electrode active area, and the positive electrode blank area is arranged around the periphery of the positive electrode active material layer.

In an achievable manner, the positive electrode blank area includes a first blank area and a second blank area, the first blank area is located on opposite sides of the positive electrode active area in the width direction, and the second blank area is located on opposite sides of the positive electrode active area in the length direction;
in the width direction, the dimension of the first blank area is K1; in the length direction, the dimension of the second blank area is K2; wherein K1>0mm, K2>0 mm.

In an achievable manner, 5 mm>K1>0 mm, 5 mm>K2>0 mm.

In an achievable manner, the second surface includes a negative electrode active area and a negative electrode blank area, the negative electrode active material layer is arranged within the negative electrode active area, and the negative electrode blank area is arranged around the periphery of the negative electrode active material layer.

In an achievable manner, the negative electrode blank area includes a third blank area and a fourth blank area, the third blank area is located on opposite sides of the negative electrode active area in the width direction, and the fourth blank area is located on opposite sides of the negative electrode active area in the length direction;
in the width direction, the dimension of the third blank area is K3; in the length direction, the dimension of the fourth blank area is K4; wherein K3>0 mm, K4>0 mm.

In an achievable manner, 3 mm>K3>0 mm, 3 mm>K4>0 mm.

In an achievable manner, the current collector is a copper aluminum composite foil; or, the material of the current collector is stainless steel.

In an achievable manner, the thickness of the current collector is H1, and H1 is between 3 μm and 10 μm;
and/or, the thickness of the positive electrode active material layer is H2, and H2 is between 80 μm and 150 μm;
and/or, the thickness of the negative electrode active material layer is H3, and H3 is between 40 μm and 100 μm.

Another embodiment of the present invention further provides a battery cell including multiple composite electrode plates as described above, wherein the multiple composite electrode plates are sequentially stacked along the thickness direction, and an electrolyte layer is provided between adjacent composite electrode plates.

In an achievable manner, in the length direction, the length of the electrolyte layer is L4; in the width direction, the width of the electrolyte layer is W4; wherein L4>L1, W4>W1.

In an achievable manner, the thickness of the current collector is H1, the thickness of the positive electrode active material layer is H2, the thickness of the negative electrode active material layer is H3, and the thickness of the electrolyte layer is H4; wherein 8>(H1+H2+H3)/H4>3.

In an achievable manner, the thickness of the electrolyte layer is H4, and H4 is between 10 μm and 45 μm.

In an achievable manner, the battery cell further includes a positive electrode plate and a negative electrode plate. In the thickness direction, the positive electrode plate and the negative electrode plate are respectively arranged on opposite sides of the multiple composite electrode plates. The electrolyte layer is provided between the positive electrode plate and an outermost composite electrode plate, as well as between the negative electrode plate and an outermost composite electrode plate.

In an achievable manner, a first current collecting layer is provided on the surface of the positive electrode plate on the side away from the composite electrode plate, and a second current collecting layer is provided on the surface of the negative electrode plate on the side away from the composite electrode plate.

The composite electrode plate provided in the present invention limits the length and width dimensions of the current collector, the positive electrode active material layer, and the negative electrode active material layer. Since the length of the positive electrode active material layer and the length of the negative electrode active material layer are smaller than the length of the current collector, and/or the width of the positive electrode active material layer and the width of the negative electrode active material layer are smaller than the width of the current collector, a size gradient is formed at the edge positions of the opposite sides of the composite electrode plate. This size gradient can reduce the step height formed between the edges of the electrolyte layer and the edges of the composite electrode plate, thereby reducing the shear force on the edges of the electrolyte layer during the hot pressing or rolling process, reducing or avoiding damage to the electrolyte layer, reducing the risk of internal short circuiting of the battery cell, improving the product quality of the battery cell, and enhancing the safety performance of the battery.

### BRIEF DESCRIPTION OF THE DRAWINGS

FIG. 1 is a schematic cross-sectional view of a battery cell in an embodiment of the present invention.

FIG. 2 is a schematic cross-sectional view of a composite electrode plate in an embodiment of the present invention.

FIG. 3 is a top view of the composite electrode plate in the embodiment of the present invention.

FIG. 4 is a bottom view of the composite electrode plate in the embodiment of the present invention.

FIG. 5 is a top view of a current collector in an embodiment of the present invention.

FIG. 6 is a bottom view of the current collector in the embodiment of the present invention.

FIG. 7 is a schematic cross-sectional view of the current collector in the embodiment of the present invention.

FIG. 8 is a schematic diagram of a planar structure of an electrolyte layer in an embodiment of the present invention.

In the figures: 100—composite electrode plate, 1—current collector, 10A—copper layer, 10B—aluminum layer, 11—first surface, 111—positive electrode active area, 112—positive electrode blank area, 1121—first blank area, 1122—second blank area, 12—second surface, 121—negative electrode active area, 122—negative electrode blank area, 1221—third blank area, 1222—fourth blank area, 2—positive electrode active material layer, 3—negative electrode active material layer, 4—electrolyte layer, 5—positive electrode plate, 51—first current collecting layer, 6—negative electrode plate, 61—second current collecting layer.

### DETAILED DESCRIPTION OF THE EMBODIMENTS

The following will provide a further detailed description of the specific implementations of the present invention in conjunction with the accompanying drawings and embodiments. The following embodiments are used to illustrate the present invention, but are not intended to limit the scope of the present invention.

The terms “first”, “second”, “third”, “fourth”, etc. (if any) in the specification and claims of the present invention are only used to distinguish similar objects, and are not intended to be used to describe a specific sequence or order.

The terms “up”, “down”, “left”, “right”, “front”, “back”, “top”, “bottom” (if any) in the specification and claims of the present invention are defined based on the position of the structure in the figures and the position between the structures in the figures, only for the clarity and convenience of expressing the technical solution. It should be understood that the use of these directional words should not limit the scope of protection in the present invention.

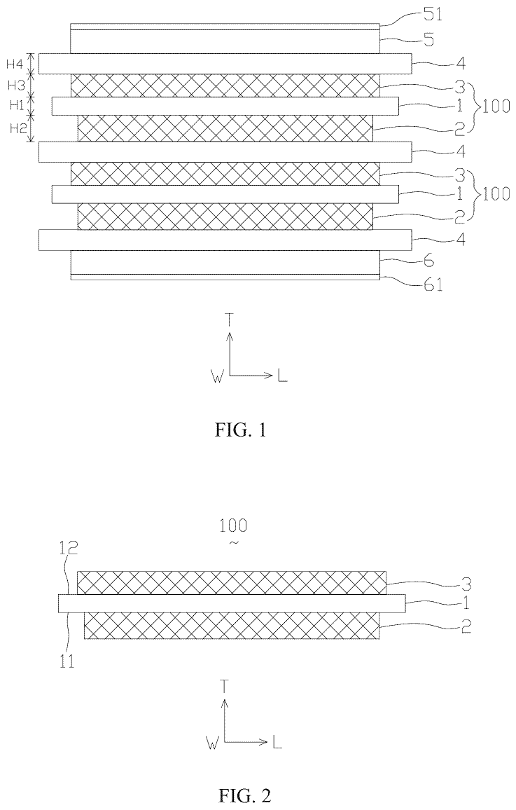

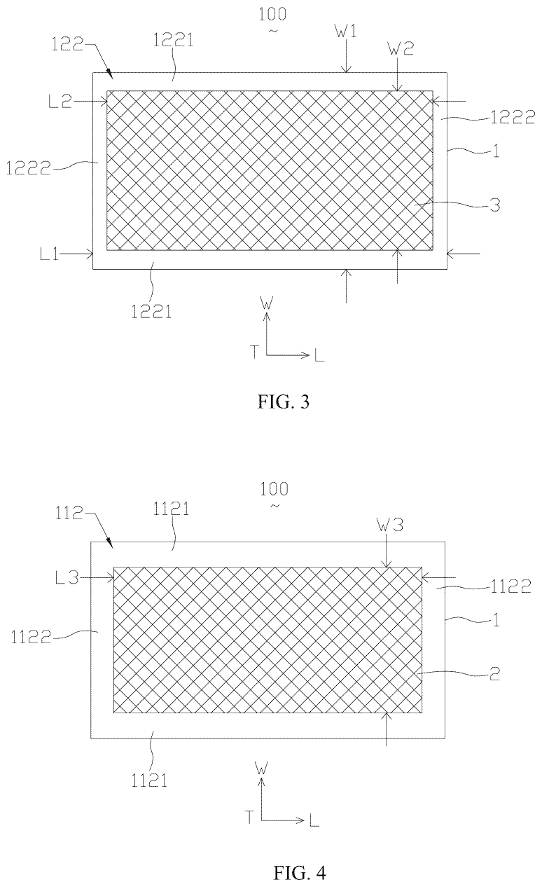

As shown in FIGS. 1 to 4, the composite electrode plate 100 provided in the embodiment of the present invention includes a current collector 1. The current collector 1 is a rectangular sheet-like structure. The current collector 1 has a length direction L, a width direction W, and a thickness direction T. In the thickness direction T, the current collector 1 has a first surface 11 and a second surface 12 that are opposite to each other; a positive electrode active material layer 2 is provided on the first surface 11, and a negative electrode active material layer 3 is provided on the second surface 12. The positive electrode active material layer 2 and the negative electrode active material layer 3 are both rectangular layered structures. Usually, every two of the length direction L, the width direction W, and the thickness direction T of the current collector 1 are mutually perpendicular to each other.

In the length direction L, the length of the current collector 1 is L1, the length of the negative electrode active material layer 3 is L2, and the length of the positive electrode active material layer 2 is L3. In the width direction W, the width of the current collector 1 is W1, the width of the negative electrode active material layer 3 is W2, and the width of the positive electrode active material layer 2 is W3. Specifically, L1>L2>L3, and/or W1>W2>W3.

Specifically, in order to better separate adjacent composite electrode plates 100, the length and width dimensions of the electrolyte layer 4 are generally larger than those of the composite electrode plate 100; compared to ordinary positive/negative electrode plates, due to the relatively large thickness of the composite electrode plate 100, and since the length and width dimensions of the positive electrode active material layer 2 and the negative electrode active material layer 3 in the existing composite electrode plate 100 are the same or similar to those of the current collector 1, there will be a more obvious step between the edges of the electrolyte layer 4 and the edges of the composite electrode plate 100 when the electrolyte layer 4 is stacked with the composite electrode plate 100. During the hot pressing or rolling process, the edges of the electrolyte layer 4 will be subjected to significant shear force due to the presence of the step. When the structural strength of the electrolyte layer 4 is insufficient to withstand this shear force, the edge positions of the electrolyte layer 4 will be damaged, causing direct contact between the positive electrode active material layer 2 and the negative electrode active material layer 3 on adjacent composite electrode plates 100, resulting in internal short circuiting of the battery cell and seriously affecting the safety performance of the battery.

In order to solve the above problems, the composite electrode plate 100 provided in this embodiment limits the length and width dimensions of the current collector 1, the positive electrode active material layer 2, and the negative electrode active material layer 3. Since the length of the positive electrode active material layer 2 and the length of the negative electrode active material layer 3 are smaller than the length of the current collector 1, and/or the width of the positive electrode active material layer 2 and the width of the negative electrode active material layer 3 are smaller than the width of the current collector 1, a size gradient is formed at the edge positions of the opposite sides of the composite electrode plate 100. When the electrolyte layer 4 is stacked with the composite electrode plate 100, this size gradient can reduce the step height formed between the edges of the electrolyte layer 4 and the edges of the composite electrode plate 100, thereby reducing the shear force on the edges of the electrolyte layer 4 during the hot pressing or rolling process, reducing or avoiding damage to the electrolyte layer 4, reducing the risk of internal short circuiting of the battery cell, improving the product yield of the battery cell, and enhancing the safety performance of the battery.

As shown in FIGS. 2, 4, and 6, as one embodiment, the first surface 11 includes a positive electrode active area 111 and a positive electrode blank area 112 (in FIG. 6, the positive electrode active area 111 and the positive electrode blank area 112 are separated by a dashed line); the positive electrode active area 111 is usually a rectangular structure, the length and width dimensions of the positive electrode active area 111 are the same as those of the positive electrode active material layer 2, and the positive electrode active material layer 2 is arranged within the positive electrode active area 111; the positive electrode blank area 112 is an annular structure, the positive electrode blank area 112 is arranged around the periphery of the positive electrode active material layer 2 (i.e., the positive electrode blank area 112 is arranged around the periphery of the positive electrode active area 111), and the positive electrode active material layer 2 is not provided in the positive electrode blank area 112. In this way, a size gradient is formed around the edges of the first surface 11 of the composite electrode plate 100. When the electrolyte layer 4 is stacked on the side of the composite electrode plate 100 near the positive electrode active material layer 2, it can effectively reduce the shear force on the edges of the electrolyte layer 4 during the hot pressing or rolling process, thereby minimizing or avoiding damage to the electrolyte layer 4 as much as possible. Meanwhile, due to a certain extensibility of the positive electrode active material layer 2, by reserving the positive electrode blank area 112 around the edges of the first surface 11, it is possible to avoid short circuiting or cross contamination caused by the extension of the positive electrode active material layer 2 outside the current collector 1 to be in direct contact with other negative electrode active material layers 3 during the hot pressing process (the hot pressing process is a high-temperature and high-pressure environment), thereby ensuring the production yield and safety of the battery cell.

As shown in FIGS. 2, 4, and 6, as one embodiment, the positive electrode blank area 112 includes a first blank area 1121 and a second blank area 1122. The first blank area 1121 is located on opposite sides of the positive electrode active area 111 in the width direction W (i.e., the first blank area 1121 is located on opposite sides of the positive electrode active material layer 2 in the width direction W), and the second blank area 1122 is located on opposite sides of the positive electrode active area 111 in the length direction L (i.e., the second blank area 1122 is located on opposite sides of the positive electrode active material layer 2 in the length direction L).

In the width direction W, the dimension of the first blank area 1121 is K1, and the dimension K1 of the first blank area 1121 on opposite sides is equal (of course, in other embodiments, the dimension K1 of the first blank area 1121 on opposite sides may not be equal). In the length direction L, the dimension of the second blank area 1122 is K2, and the dimension K2 of the second blank area 1122 on opposite sides is equal (of course, in other embodiments, the dimension K2 of the second blank area 1122 on opposite sides may not be equal). Specifically, K1>0 mm, K2>0 mm.

Specifically, due to the extension of the positive electrode active material layer 2 along the width direction W and the length direction L during the hot pressing process, K1 and K2 are set to be greater than 0 to better avoid short circuiting or cross contamination caused by the extension of the positive electrode active material layer 2 outside the current collector 1 to be in direct contact with other negative electrode active material layers 3 during the hot pressing process.

As one embodiment, 5 mm>K1>0 mm, 5 mm>K2>0 mm; alternatively, 4 mm>K1>2 mm, 4 mm>K2>2 mm.

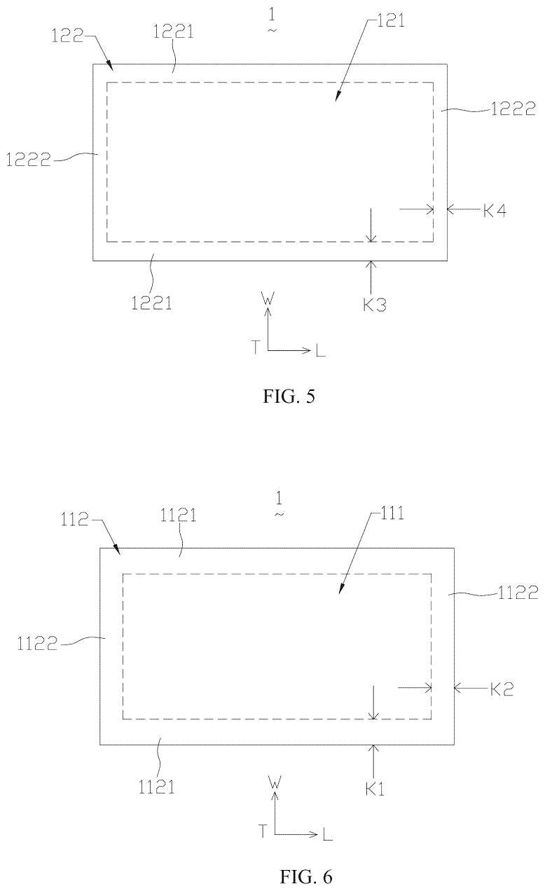

As shown in FIGS. 2, 3, and 5, as one embodiment, the second surface 12 includes a negative electrode active area 121 and a negative electrode blank area 122 (in FIG. 5, the negative electrode active area 121 and the negative electrode blank area 122 are separated by a dashed line); the negative electrode active area 121 is usually a rectangular structure, and the length and width dimensions of the negative electrode active area 121 are the same as those of the negative electrode active material layer 3, and the negative electrode active material layer 3 is arranged within the negative electrode active area 121; the negative electrode blank area 122 is an annular structure, the negative electrode blank area 122 is arranged around the periphery of the negative electrode active material layer 3 (i.e., the negative electrode blank area 122 is arranged around the periphery of the negative electrode active area 121), and the negative electrode active material layer 3 is not provided in the negative electrode blank area 122. In this way, a size gradient is formed around the edges of the second surface 12 of the composite electrode plate 100. When the electrolyte layer 4 is stacked on the side of the composite electrode plate 100 near the negative electrode active material layer 3, it can effectively reduce the shear force on the edges of the electrolyte layer 4 during the hot pressing or rolling process, thereby minimizing or avoiding damage to the electrolyte layer 4 as much as possible. Meanwhile, due to a certain extensibility of the negative electrode active material layer 3, by reserving the negative electrode blank area 122 around the edges of the second surface 12, it is possible to avoid short circuiting or cross contamination caused by the extension of the negative electrode active material layer 3 outside the current collector 1 to be in direct contact with other positive electrode active material layers 2 during the hot pressing process, thereby ensuring the production yield and safety of the battery cell.

As shown in FIGS. 2, 3, and 5, as one embodiment, the negative electrode blank area 122 includes a third blank area 1221 and a fourth blank area 1222. The third blank area 1221 is located on opposite sides of the negative electrode active area 121 in the width direction W (i.e., the third blank area 1221 is located on opposite sides of the negative electrode active material layer 3 in the width direction W), and the fourth blank area 1222 is located on opposite sides of the negative electrode active area 121 in the length direction L (i.e., the fourth blank area 1222 is located on opposite sides of the negative electrode active material layer 3 in the length direction L).

In the width direction W, the dimension of the third blank area 1221 is K3, and the dimension K3 of the third blank area 1221 on opposite sides is equal (of course, in other embodiments, the dimension K3 of the third blank area 1221 on opposite sides may not be equal). In the length direction L, the dimension of the fourth blank area 1222 is K4, and the dimension K4 of the fourth blank area 1222 on opposite sides is equal (of course, in other embodiments, the dimension K4 of the fourth blank area 1222 on opposite sides may not be equal). Specifically, K3>0 mm, K4>0 mm.

Specifically, due to the extension of the negative electrode active material layer 3 along the width direction W and the length direction L during the hot pressing process, K3 and K4 are set to be greater than 0 to better avoid short circuiting or cross contamination caused by the extension of the negative electrode active material layer 3 outside the current collector 1 to be in direct contact with other positive electrode active material layers 2 during the hot pressing process.

As one embodiment, 3 mm>K3>0 mm, 3 mm>K4>0 mm; alternatively, 2.5 mm>K3>1 mm, 2.5 mm>K4>1 mm.

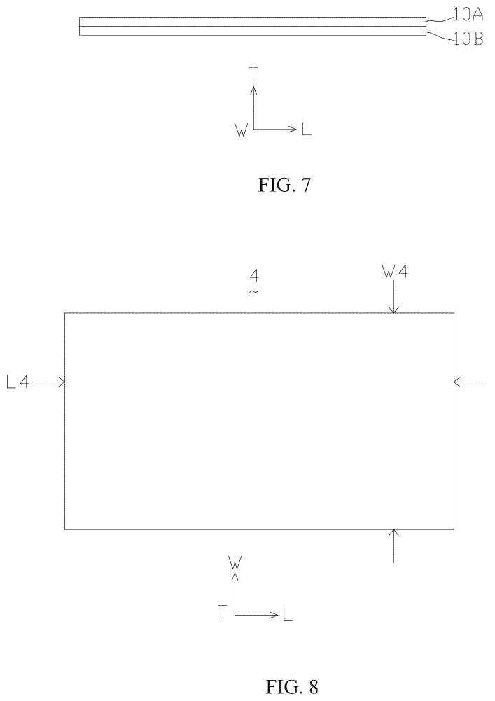

As shown in FIGS. 2 and 7, as one embodiment, the current collector 1 is a copper aluminum composite foil. The current collector 1 includes a copper layer 10A and an aluminum layer 10B that are stacked along the thickness direction T. The negative electrode active material layer 3 is provided on the surface of the copper layer 10A, and the positive electrode active material layer 2 is provided on the surface of the aluminum layer 10B. As another embodiment, the material of the current collector 1 is stainless steel, that is, the current collector 1 includes a stainless steel layer (not shown), and the negative electrode active material layer 3 and the positive electrode active material layer 2 are respectively provided on the surfaces of opposite sides of the stainless steel layer.

As shown in FIG. 1, as one embodiment, the thickness of the current collector 1 is H1. H1 is between 3 μm and 10 μm, or between 5 μm and 15 μm, or between 10 μm and 20 μm. The thickness of the positive electrode active material layer 2 is H2. H2 is between 80 μm and 150 μm, or between 90 μm and 180 μm, or between 100 μm and 200 μm. The thickness of the negative electrode active material layer 3 is H3. H3 is between 40 μm and 100 μm, or between 5 μm and 20 μm, or between 10 μm and 30 μm, or between 15 μm and 40 μm.

As shown in FIG. 1, an embodiment of the present invention further provides a battery cell including multiple above-mentioned composite electrode plates 100 (two composite electrode plates 100 are illustrated in FIG. 1, but the number of the composite electrode plates 100 can be even more). The multiple composite electrode plates 100 are sequentially stacked along the thickness direction T, an electrolyte layer 4 is provided between adjacent composite electrode plates 100, and the electrolyte layer 4 is used to insulate and separate adjacent composite electrode plates 100. Specifically, for every two adjacent composite electrode plates 100, the positive electrode active material layer 2 on one composite electrode plate 100 is adjacent to the negative electrode active material layer 3 on the other composite electrode plate 100, and the electrolyte layer 4 is arranged between the positive electrode active material layer 2 and the negative electrode active material layer 3 of the adjacent two composite electrode plates 100 to insulate and separate the adjacent positive electrode active material layer 2 and negative electrode active material layer 3.

Specifically, due to the use of the composite electrode plate 100 in the battery cell, and the fact that the composite electrode plate 100 includes a positive electrode active material layer 2 and a negative electrode active material layer 3, compared to traditional batteries using positive and negative electrode plates, it can reduce the mass proportion of the current collector 1 in the entire battery cell, thereby improving energy density.

As shown in FIGS. 1 and 8, as one embodiment, in the length direction L, the length of the electrolyte layer 4 is L4; in the width direction W, the width of the electrolyte layer 4 is W4. Specifically, L4>L1, that is, L4>L1>L2>L3; W4>W1, that is, W4>W1>W2>W3. The edges of the electrolyte layer 4 extend beyond the edges of the composite electrode plate 100, thus allowing the electrolyte layer 4 to completely cover the composite electrode plate 100 and provide better insulation.

As one embodiment, 100 mm>L4>L1>L2>L3>50 mm, 80 mm>W4>W1>W2>W3>30 mm; or 110 mm>L4>L1>L2>L3>60 mm, 90 mm>W4>W1>W2>W3>40 mm; or 90 mm>L4>L1>L2>L3>40 mm, 70 mm>W4>W1>W2>W3>20 mm; or 80 mm>L4>L1>L2>L3>30 mm,60 mm>W4>W1>W2>W3>10 mm.

As one embodiment, the electrolyte layer 4 is a solid electrolyte membrane.

As one embodiment, the multiple composite electrode plates 100 and each electrolyte layer 4 are bonded together by hot pressing. Due to the size gradient formed at the edge positions of the opposite sides of the composite electrode plate 100, the shear force on the edges of the electrolyte layer 4 during the hot pressing process is reduced, thereby reducing or avoiding damage to the electrolyte layer 4.

As shown in FIG. 1, as one embodiment, the thickness of the current collector 1 is H1, the thickness of the positive electrode active material layer 2 is H2, the thickness of the negative electrode active material layer 3 is H3, and the thickness of the electrolyte layer 4 is H4; specifically, 8>(H1+H2+H3)/H4>3, or 6>(H1+H2+H3)/H4>4, or 9>(H1+H2+H3)/H4>2.

Specifically, H1+H2+H3 refers to the total thickness of the composite electrode plate 100. According to actual testing, when the total thickness of the composite electrode plate 100 is greater than 3 times and less than 8 times the thickness of the electrolyte layer 4 (i.e., when the total thickness of the composite electrode plate 100 is relatively thick), using the above structure can achieve a more significant effect in preventing damage to the electrolyte layer 4 (while when the total thickness of the composite electrode plate 100 is relatively thin, such as when the total thickness of the composite electrode plate 100 is less than 3 times the thickness of the electrolyte layer 4, the effect of using the above structure on preventing damage to the electrolyte layer 4 is relatively less significant). Of course, in other embodiments, when the ratio of the total thickness of the composite electrode plate 100 to the thickness of the electrolyte layer 4 is not within the above range, the composite electrode plate 100 can also adopt the above structure.

As one embodiment, the thickness H4 of the electrolyte layer 4 is between 10 μm and 45 μm, or between 5 μm and 30 μm, or between 15 μm and 50 μm.

As one embodiment, the above-mentioned battery cell can be a laminated battery cell or a wound battery cell. Specifically, the laminated battery cell is formed by stacking multiple composite electrode plates 100 and electrolyte layers 4; the wound battery cell is formed by stacking multiple composite electrode plates 100 and electrolyte layers 4 and winding them together. The wound battery cell can be a cylindrical battery cell (i.e., multiple composite electrode plates 100 and electrolyte layers 4 are stacked and wound into a cylindrical structure) or a square battery cell (i.e., multiple composite electrode plates 100 and electrolyte layers 4 are stacked and wound into a square structure).

As shown in FIG. 1, as one embodiment, the battery cell further includes a positive electrode plate 5 and a negative electrode plate 6. In the thickness direction T, the positive electrode plate 5 and the negative electrode plate 6 are respectively arranged on opposite sides of the multiple composite electrode plates 100. The electrolyte layer 4 is provided between the positive electrode plate 5 and an outermost composite electrode plate 100, as well as between the negative electrode plate 6 and an outermost composite electrode plate 100.

Specifically, the positive electrode plate 5 is arranged adjacent to the negative electrode active material layer 3 on the outermost composite electrode plate 100, and the negative electrode plate 6 is arranged adjacent to the positive electrode active material layer 2 on the outermost composite electrode plate 100. The positive electrode plate 5 includes a positive electrode active material layer (not shown), and the electrolyte layer 4 insulates and separates the positive electrode plate 5 from the negative electrode active material layer 3 on the outermost composite electrode plate 100; the negative electrode plate 6 includes a negative electrode active material layer (not shown), and the electrolyte layer 4 insulates and separates the negative electrode plate 6 from the positive electrode active material layer 2 on the outermost composite electrode plate 100.

As shown in FIG. 1, as one embodiment, a first current collecting layer 51 is provided on the surface of the positive electrode plate 5 on the side away from the composite electrode plate 100, and a second current collecting layer 61 is provided on the surface of the negative electrode plate 6 on the side away from the composite electrode plate 100. The first current collecting layer 51 and the second current collecting layer 61 play a role in current collection. The first current collecting layer 51 and the second current collecting layer 61 can be respectively connected to electrode tabs (not shown) to connect with external circuits through the electrode tabs. The first current collecting layer 51 and the second current collecting layer 61 can specifically be collector foils, which are high-strength conductive foils that can meet overcurrent requirements, with the materials being stainless steel, copper, aluminum, composite foils (copper aluminum composite material, copper stainless steel composite material, etc.), etc.

An embodiment of the present invention further provides an all solid state battery including the above-mentioned battery cell.

The composite electrode plate 100 provided in this embodiment limits the length and width dimensions of the current collector 1, the positive electrode active material layer 2, and the negative electrode active material layer 3. Since the length of the positive electrode active material layer 2 and the length of the negative electrode active material layer 3 are smaller than the length of the current collector 1, and/or the width of the positive electrode active material layer 2 and the width of the negative electrode active material layer 3 are smaller than the width of the current collector 1, a size gradient is formed at the edge positions of the opposite sides of the composite electrode plate 100. When the electrolyte layer 4 is stacked with the composite electrode plate 100, this size gradient can reduce the step height formed between the edges of the electrolyte layer 4 and the edges of the composite electrode plate 100, thereby reducing the shear force on the edges of the electrolyte layer 4 during the hot pressing or rolling process, reducing or avoiding damage to the electrolyte layer 4, reducing the risk of internal short circuiting of the battery cell, improving the product yield of the battery cell, and enhancing the safety performance of the battery.

Meanwhile, by setting a blank area at the edges of the current collector 1, it is possible to avoid short circuiting or cross contamination caused by the extension of the positive electrode active material layer 2 or negative electrode active material layer 3 outside the current collector 1 during the hot pressing process, thereby ensuring the production yield and safety of the battery cell.

The above are only the specific embodiments of the present invention, but the scope of protection of the present invention is not limited to this. Any technical personnel familiar with this technical field who can easily think of changes or replacements within the scope of technology disclosed in the present invention should be covered within the scope of protection of the present invention. Therefore, the protection scope of the present invention should be based on the protection scope of the claims.

1. A composite electrode plate comprising a current collector, wherein the current collector has a length direction, a width direction, and a thickness direction; in the thickness direction, the current collector has a first surface and a second surface that are opposite to each other; a positive electrode active material layer is provided on the first surface, and a negative electrode active material layer is provided on the second surface;
in the length direction, the length of the current collector is L1, the length of the negative electrode active material layer is L2, and the length of the positive electrode active material layer is L3; in the width direction, the width of the current collector is W1, the width of the negative electrode active material layer is W2, and the width of the positive electrode active material layer is W3; wherein L1>L2>L3, and/or W1>W2>W3.

2. The composite electrode plate as claimed in claim 1, wherein the first surface comprises a positive electrode active area and a positive electrode blank area, the positive electrode active material layer is arranged within the positive electrode active area, and the positive electrode blank area is arranged around the periphery of the positive electrode active material layer.

3. The composite electrode plate as claimed in claim 2, wherein the positive electrode blank area comprises a first blank area and a second blank area the first blank area is located on opposite sides of the positive electrode active area in the width direction, and the second blank arca is located on opposite sides of the positive electrode active area in the length direction;
in the width direction, the dimension of the first blank area is K1; in the length direction, the dimension of the second blank area is K2; wherein K1>0 mm, K2>0 mm.

4. The composite electrode plate as claimed in claim 3, wherein 5 mm>K1>0 mm, 5 mm>K2>0 mm.

5. The composite electrode plate as claimed in claim 2, wherein the second surface comprises a negative electrode active area and a negative electrode blank area, the negative electrode active material layer is arranged within the negative electrode active area, and the negative electrode blank area is arranged around the periphery of the negative electrode active material layer.

6. The composite electrode plate as claimed in claim 1, wherein the second surface comprises a negative electrode active area and a negative electrode blank area, the negative electrode active material layer is arranged within the negative electrode active area, and the negative electrode blank area is arranged around the periphery of the negative electrode active material layer.

7. The composite electrode plate as claimed in claim 6, wherein the negative electrode blank area comprises a third blank area and a fourth blank area the third blank area is located on opposite sides of the negative electrode active area in the width direction, and the fourth blank area is located on opposite sides of the negative electrode active area in the length direction;
in the width direction, the dimension of the third blank area is K3; in the length direction, the dimension of the fourth blank area is K4; wherein K3>0 mm, K4>0 mm.

8. The composite electrode plate as claimed in claim 7, wherein 3 mm>K3>0 mm, 3 mm>K4>0 mm.

9. The composite electrode plate as claimed in claim 1, wherein the current collector is a copper aluminum composite foil; or, the material of the current collector is stainless steel.

10. The composite electrode plate as claimed in claim 1, wherein the thickness of the current collector is H1, and H1 is between 3 μm and 10 μm;
and/or, the thickness of the positive electrode active material layer is H2, and H2 is between 80 μm and 150 μm;
and/or, the thickness of the negative electrode active material layer is H3, and H3 is between 40 μm and 100 μm.

11. A battery cell comprising multiple composite electrode plates as claimed in claim 1, wherein the multiple composite electrode plates are sequentially stacked along the thickness direction, and an electrolyte layer is provided between adjacent composite electrode plates.

12. The battery cell as claimed in claim 11, wherein in the length direction, the length of the electrolyte layer is L4; in the width direction, the width of the electrolyte layer is W4; wherein L4>L1, W4>W1.

13. The battery cell as claimed in claim 11, wherein the thickness of the current collector is H1, the thickness of the positive electrode active material layer is H2, the thickness of the negative electrode active material layer is H3, and the thickness of the electrolyte layer is H4; wherein 8>(H1+H2+H3)]]/H4>3.

14. The battery cell as claimed in claim 11, wherein the thickness of the electrolyte layer is H4, and H4 is between 10 μm and 45 μm.

15. A battery cell comprising multiple composite electrode plates as claimed in claim 5, wherein the multiple composite electrode plates are sequentially stacked along the thickness direction, and an electrolyte layer is provided between adjacent composite electrode plates.

16. The battery cell as claimed in claim 15, wherein in the length direction, the length of the electrolyte layer is L4; in the width direction, the width of the electrolyte layer is W4; wherein L4>L1, W4>W1.

17. The battery cell as claimed in claim 15, wherein the thickness of the current collector is H1, the thickness of the positive electrode active material layer is H2, the thickness of the negative electrode active material layer is H3, and the thickness of the electrolyte layer is H4; wherein 8>(H1+H2+H3)/H4>3.

18. The battery cell as claimed in claim 15, wherein the thickness of the electrolyte layer is H4, and H4 is between 10 μm and 45 μm.
